(19) United States
(12) Patent Application Publication
(10) Pub. No.: US 2002/0154842 A1
(43) Pub. Date: Oct. 24, 2002

(54) Drive techniques for loaded-line optical modulators

(76) Inventor: Gary E. Betts, Westford, MA (US)

Correspondence Address: TERRANCE A. MEADOR, GRAY CARY WARE & FREIDENRICH, LLP, 4365 EXECUTIVE DRIVE, SUITE 1100, SAN DIEGO, CA, 92121-2133, US

(21) Appl. No.: 09/946,710

(22) Filed: Sep. 4, 2001

Related U.S. Application Data
(60) Provisional application No. 60/285,436, filed on Apr. 19, 2001.

(51) Int. Cl. G02F 1/035

(52) U.S. Cl. 385/2

(57) ABSTRACT

A loaded-line optical modulator includes an optical waveguide having first and second interferometric arms, a drive signal electrode, and a plurality of loading capacitors connected to the drive signal electrode. The loading capacitors are asymmetrically configured such that the amount of modulation in the first interferometric arm differs from the amount of modulation in the second interferometric arm. The asymmetric nature of the loading capacitors generates a nonzero chirp in the modulated optical signal. Various dual-drive techniques for a loaded-line optical modulator having a plurality of drive electrodes are also disclosed.

### CROSS REFERENCE TO RELATED APPLICATIONS

This application claims priority of, and incorporates by reference, U.S. provisional patent application serial No. 60/285,436, filed Apr. 19, 2001.

### STATEMENT REGARDING FEDERALLY SPONSORED RESEARCH OR DEVELOPMENT

The subject matter disclosed herein was made in part with United States government support under contract/grant number F19628-00-C-0002 awarded by the United States Air Force. The United States government has certain rights to the invention claimed herein.

### FIELD OF THE INVENTION

The present invention relates generally to optical modulators. More particularly, the present invention relates to drive techniques for loaded-line optical modulators.

### BACKGROUND OF THE INVENTION

Many high speed digital communication systems employ optical modulators, such as Mach-Zehnder optical modulators. Mach-Zehnder optical modulators are well known to those skilled in the art and, therefore, are not described in detail herein. Briefly, a typical Mach-Zehnder optical modulator receives a data signal from a driver amplifier component, along with an unmodulated continuous wave (CW) optical input. The optical modulator modulates the optical signal in response to the electrical data signal. The optical input is carried by an optical waveguide formed within a substrate, and the electrical data signal propagates over a transmission line located above the optical waveguide.

A Mach-Zehnder optical modulator may utilize a loaded-line electrode configuration. Conventional loaded-line optical modulators include a single drive electrode and two ground electrodes that cooperate to modulate the optical signal carried within the optical waveguide (Mach-Zehnder modulators employ a waveguide having two interferometric arms). An optical modulator using a single drive electrode can be undesirable in certain applications due to the relatively high driving voltage requirements. In addition, the configuration of known loaded-line optical modulators and their associated drive techniques may be undesirable in some practical applications. For example, conventional loaded-line optical modulators are not designed to provide a fixed or adjustable nonzero chirp in the modulated signal.

### BRIEF SUMMARY OF THE INVENTION

An optical modulator according to the present invention may employ a loaded-line electrode structure having asymmetric loading capacitors. The difference in the loading electrodes generates a nonzero chirp in the modulated optical signal. A loaded-line optical modulator according to the present invention may include a plurality of drive signal electrodes that provide respective drive signals to an optical waveguide.

### BRIEF DESCRIPTION OF THE DRAWINGS

A more complete understanding of the present invention may be derived by referring to the detailed description and claims when considered in conjunction with the following Figures, wherein like reference numbers refer to similar elements throughout the Figures.

FIG. 1 is a schematic top view of a prior art loaded-line optical modulator;

FIG. 2 is a schematic representation of the prior art loaded-line optical modulator shown in FIG. 1;

FIG. 3 is a schematic representation of a loaded-line optical modulator having asymmetric loading capacitors;

FIG. 4 is a schematic top view of a loaded-line optical modulator having asymmetric loading capacitors;

FIG. 5 is a schematic top view of an alternately configured loaded-line optical modulator having asymmetric loading capacitors;

FIG. 6 is a schematic representation of an optical modulator subsystem including a loaded-line optical modulator with dual drive electrodes;

FIG. 7 is a schematic perspective view of a loaded-line optical modulator having dual drive electrodes;

FIG. 8 is a schematic representation of an optical modulator subsystem including a loaded-line optical modulator with dual drive electrodes and asymmetric loading capacitors; and

FIG. 9 is a schematic representation of an alternate optical modulator subsystem including a loaded-line modulator with dual drive electrodes and symmetric loading capacitors.

### DETAILED DESCRIPTION OF PREFERRED EMBODIMENTS

The particular implementations shown and described herein are illustrative of the invention and its best mode and are not intended to otherwise limit the scope of the invention in any way. Indeed, for the sake of brevity, the operation of conventional optical modulators, conventional RF design techniques, and functional aspects of known components and subsystems may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical embodiment.

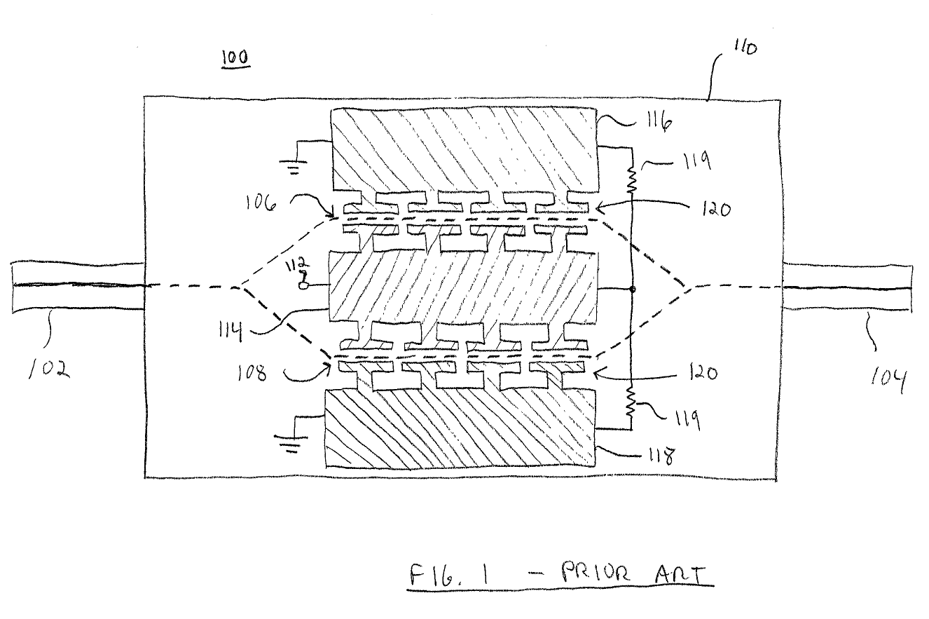

FIG. 1 is a schematic top view of a prior art Mach-Zehnder loaded-line optical modulator 100. Optical modulator 100 receives a continuous wave (CW) optical input signal carried by an input optical fiber 102 and generates a modulated optical output signal carried by an output optical fiber 104. The optical signal travels in a branched optical waveguide arrangement having a first interferometric arm 106 and a second interferometric arm 108. The optical waveguide is formed within a substrate layer 110 of optical modulator 100. In a practical embodiment, the optical waveguide resides underneath both a dielectric layer and a transmission line layer of optical modulator 100 (for this reason, the optical waveguide, which would otherwise be hidden from view, is represented by dashed lines in FIG. 1).

A high frequency electrical data signal (e.g., an RF signal) is utilized to drive optical modulator 100. Optical modulator 100 receives the electrical drive signal via a suitable data input connection 112. The drive signal is carried by a suitable drive signal electrode 114. Optical modulator 100 also includes a first ground electrode 116 and a second ground electrode 118. Drive signal electrode 114, first ground electrode 116, and second ground electrode 118 (these electrodes can be located above the dielectric layer) combine to form a microwave transmission line, which is terminated by suitable resistances 119. The electrical data signal modulates the optical signal in first interferometric arm 106 (due to the positioning of drive signal electrode 114 and first ground electrode 116 relative to first interferometric arm 106), and modulates the optical signal in second interferometric arm 108 (due to the positioning of drive signal electrode 114 and second ground electrode 118 relative to second interferometric arm 108).

Optical modulator 100 includes a plurality of loading capacitors 120 that run along the lengths of first interferometric arm 106 and second interferometric arm 108. Drive signal electrode 114, first ground electrode 116, and second ground electrode 118 include (or are connected to) the capacitor electrodes. In FIG. 1, capacitors 120 are each realized by T-shaped protrusions from drive signal electrode 114, first ground electrode 116, and second ground electrode 118. As shown in FIG. 1, prior art loaded-line optical modulators utilize symmetric loading capacitors such that the overall capacitance corresponding to the first interferometric arm is balanced with the overall capacitance corresponding to the second interferometric arm. Indeed, all of the individual capacitors are designed with the same capacitance. The symmetric nature of such prior art loaded-line optical modulators is necessary to maintain zero chirp in the modulated optical signal.

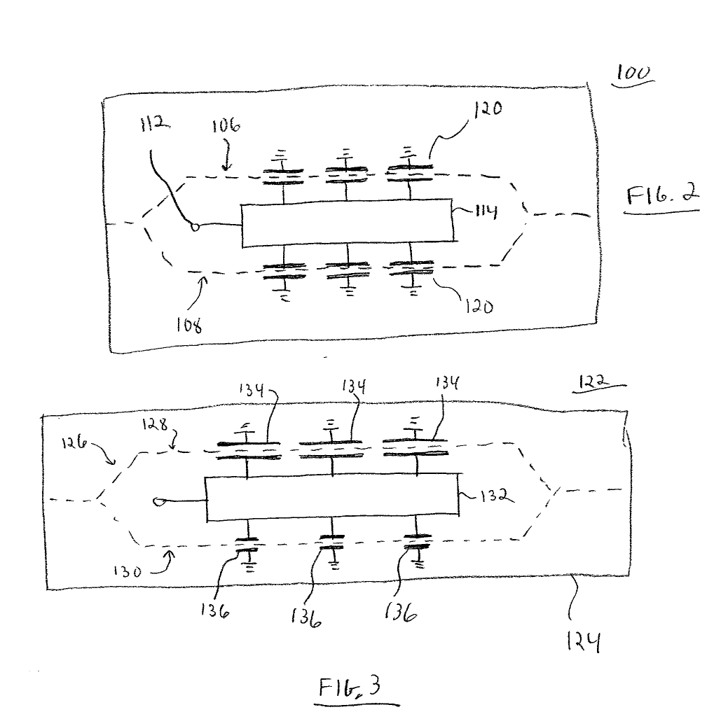

FIG. 2 is a schematic representation of the prior art loaded-line optical modulator 100 shown in FIG. 1. For the sake of clarity, the ground electrodes are represented by electrical ground symbols and drive signal electrode 114 is represented by a rectangular strip. Each loading capacitor 120 is represented by an electrical capacitor symbol. As described above, each loading capacitor 120 has the same capacitance; FIG. 2 depicts dimensionally symmetric capacitors 120 having equal lengths.

FIG. 3 is a schematic representation of a loaded-line optical modulator 122 having asymmetric loading capacitors. Optical modulator 122, which is configured as a Mach-Zehnder modulator, may be formed on a suitable substrate 124. Optical modulator 122 can be manufactured using different device technologies. For example, optical modulators may utilize semiconductor, lithium niobate, or polymer technologies. For various reasons, optical modulators having lithium niobate substrates are often used in practical high speed applications. Although most practical embodiments of the present invention employ lithium niobate, the present invention is not limited to any particular device technology. Indeed, a semiconductor-based optical modulator substrate may be desirable in some designs, particularly those in which the RF driver devices are fabricated into the semiconductor substrate alongside the modulator transmission lines. Furthermore, the example embodiments described herein relate to applications using x-cut lithium niobate. Other possible applications include z-cut lithium niobate applications (which use the vertical electric field rather than the horizontal electric field) and semiconductor modulators (which can be similar in general form and which can employ vertical or horizontal fields, but may use doped layers in the semiconductor as well as metal for the electrodes).

Optical modulator 122 includes an optical waveguide 126 having a first interferometric arm 128 and a second interferometric arm 130. The input optical signal enters optical waveguide 126, is divided in the input waveguide branch, and is recombined in the output waveguide branch. The optical signal component that travels in first interferometric arm 128 and the optical signal component that travels in second interferometric arm 130 are independently modulated by the input data signal (as described in more detail below).

Optical modulator 122 includes a drive signal electrode 132 shared by first interferometric arm 128 and second interferometric arm 130. In other words, optical modulator 122 can utilize a single drive electrode 132 to drive both waveguide arms. In this respect, drive signal electrode 132 is configured to contribute to the modulation of optical signals in first interferometric arm 128 and in second interferometric arm 130. Although not shown in FIG. 3, optical modulator 122 includes one or more ground electrodes that cooperate with drive signal electrode 132.

Optical modulator 122 includes a plurality of asymmetric loading capacitance structures connected to drive signal electrode 132. As used herein, a “loading capacitance structure” is any number of distinct components, devices, features, or elements capable of functioning as an electrical capacitor. For example, a loading capacitance structure can be a single capacitor element, a network of individual capacitor elements, or a circuit that exhibits capacitive characteristics. In the example embodiment shown in FIG. 3, optical modulator 122 includes a first loading capacitance structure comprising a plurality of capacitors 134 coupled to drive signal electrode 132 and located proximate to first interferometric arm 128, and a second loading capacitance structure comprising a plurality of capacitors 136 coupled to drive signal electrode 132 and located proximate to second interferometric arm 130. Notably, the single drive signal electrode 132 is connected to both the first and second loading capacitance structures.

The first loading capacitance structure of optical modulator 122 has a different capacitance than the second loading capacitance structure. For example, capacitors 134 can be configured to provide a first combined loading capacitance, and capacitors 136 can be configured to provide a second combined loading capacitance. In a practical embodiment (and as shown in FIG. 3), each capacitor 134 exhibits substantially the same capacitance relative to each other, and each capacitor 136 exhibits substantially the same capacitance relative to each other. However, capacitors 134 and capacitors 136 are dimensionally asymmetric such that their respective capacitances are different. For example, if the capacitor lengths in a symmetric loaded-line optical modulator (see FIG. 2) are l, then the length of each capacitor 134 may be (l+a) and the length of each capacitor 136 may be (l−a), where a is a suitable differential length. Consequently, the overall combined loading capacitance of optical modulator 122 need not differ from the overall combined loading capacitance of an equivalently designed loaded-line optical modulator having symmetric loading capacitors.

The first loading capacitance structure and the second loading capacitance structure are suitably configured to generate a nonzero chirp in a modulated optical signal. This is done by creating some asymmetry between the two interferometer arms in the amount of phase modulation produced by the voltage applied to the drive electrode. This can be done by making the electrode lengths asymmetric as shown in FIG. 3 and as explained below. Another way to introduce asymmetry is to vary the electrode gap, such that, for example, the gap for a loading capacitor on the first arm is wider than the gap for a loading capacitor on the second arm. This configuration reduces the electric field and the corresponding phase modulation in the arm with the wider gap. In still another form of asymmetry, a symmetric electrode pattern can be aligned asymmetrically so that one arm of the interferometer is as shown in FIG. 2 but the other arm does not pass under the electrode gap so it experiences a weaker field and hence less phase modulation. Even further methods of introducing asymmetry can be imagined, but such techniques may not be as efficient or straightforward as the electrode length variation techniques described herein.

In one practical embodiment, optical modulator 122 can be designed to provide a fixed nonzero chirp by using a longer electrode on one arm than on the other. The longer electrode produces more phase modulation than the shorter electrode, since both have the same voltage applied and phase modulation is proportional to voltage times length, all other things being equal. When the light from the two arms is recombined at the output Y branch of waveguide 126, there will be a net phase modulation (in the symmetric device of FIG. 2, the phase modulation is equal and opposite in the two arms so there is no phase modulation of the output light). This time-dependent phase modulation is an optical frequency modulation and is referred to as “chirp.” Chirp is generally undesirable because it unnecessarily broadens the bandwidth of the transmitted optical signal, but in some specific cases a controlled amount of chirp is helpful as it can be used to achieve a small amount of pulse compression over an optical communication link of known distance and dispersion.

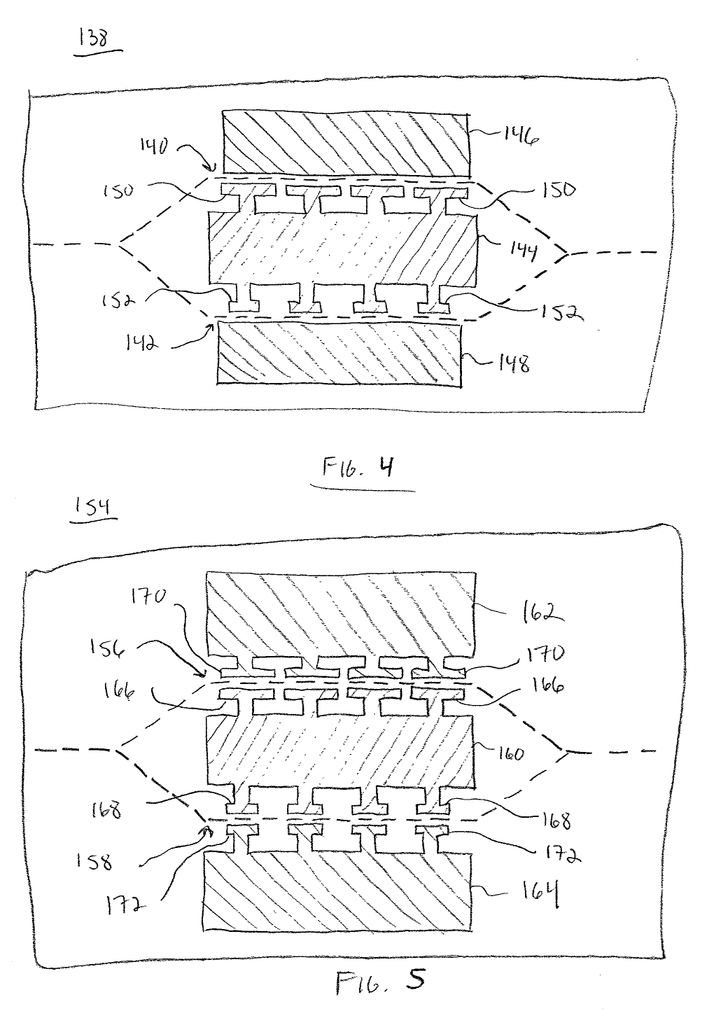

Optical modulator 122 can be realized in any number of equivalent forms. For example, the optical modulator 138 shown in FIG. 4 includes an optical waveguide having a first interferometric arm 140 and a second interferometric arm 142, a drive signal electrode 144, a first ground electrode 146, and a second ground electrode 148. Drive signal electrode 144 is connected to a first plurality of load electrodes 150 having a first length and to a second plurality of load electrodes 152 having a second length (different than the first length). These load electrodes, in conjunction with first ground electrode 146 and second ground electrode 148, provide asymmetric capacitances for generating a nonzero chirp.

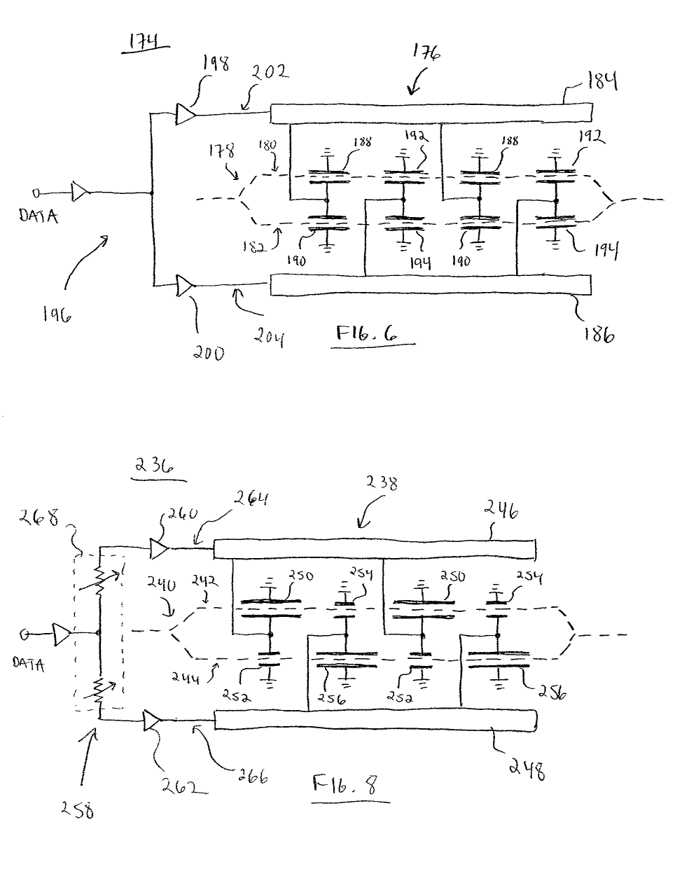

Similarly, optical modulator 154 shown in FIG. 5 includes an optical waveguide having a first interferometric arm 156 and a second interferometric arm 158, a drive signal electrode 160, a first ground electrode 162, and a second ground electrode 164. Drive signal electrode 160 is connected to a first plurality of load electrodes 166 having a first length and to a second plurality of load electrodes 168 having a second length (different than the first length). First ground electrode 162 is connected to a plurality of ground elements 170 corresponding to load electrodes 166, and second ground electrode 164 is connected to a plurality of ground elements 172 corresponding to load electrodes 168. In the embodiment shown in FIG. 5, the length of each load electrode 166 equals the length of the corresponding ground element 170, and the length of each load electrode 168 equals the length of the corresponding ground element 172. The load electrodes, in conjunction with the corresponding ground elements, provide asymmetric capacitances for generating a nonzero chirp. In this respect, the optical modulator structure and configuration can be used to select a nonzero chirp. The type of design shown in FIGS. 3-5 is capable of generating a nonzero fixed chirp with a range of possible values for the chirp. The device can be driven from a single input, and there is no penalty in drive voltage for changing the chirp value when the length of the loading capacitors in the symmetric case is limited by velocity and impedance considerations to be less than half the total length available.

The example embodiments shown in FIGS. 3-5 are not intended to restrict or otherwise limit the scope of the present invention, and alternate transmission line layouts and loading capacitor arrangements can be utilized in a practical implementation. For example, an asymmetric loaded-line optical modulator can employ a number of symmetric loading capacitors combined with a number of asymmetric loading capacitors. As described above, the difference between the combined capacitance corresponding to the first interferometric arm and the combined capacitance corresponding to the second interferometric arm can be suitably selected according to various design parameters, and the asymmetry in the capacitances can be accomplished by using dimensionally asymmetric capacitors, by using a different number of loading capacitors for each interferometric arm, or the like. In addition, an asymmetric loaded-line optical modulator need not employ periodically spaced loading capacitors.

FIG. 6 is a schematic representation of an optical modulator subsystem 174 including a loaded-line optical modulator 176 with dual drive electrodes. A dual-drive configuration can be used to lower the modulator drive voltage typically associated with conventional single drive designs (under some practical circumstances, the drive voltage can be reduced by 50%). The magnitude of the modulation drive voltage is inversely proportional to the length of the waveguide that is covered by the loading electrodes; the drive voltage decreases as the length of the loading electrodes increases. However, longer loading electrodes result in additional loading capacitance and the total electrode length is limited because only a limited amount of capacitance can be added before the electrical velocity is reduced to a value that is less than the optical velocity. The most efficient modulating electrodes have a high capacitance per unit length, and practical loading electrodes are often limited to less than half of the total waveguide length available. Thus, a second RF drive signal electrode can be used to double the length that is covered, so that each drive signal electrode can be driven with only half of the voltage required by an equivalent modulator having a single drive electrode.

Optical modulator 176 includes an optical waveguide 178 having a first interferometric arm 180 and a second interferometric arm 182, a first drive signal electrode 184, a second drive signal electrode 186, and a plurality of loading capacitors located proximate the two interferometric arms. Optical modulator 176 includes a first loading capacitance structure (e.g., a plurality of capacitors 188) located proximate to first interferometric arm 180 and coupled between first drive signal electrode 184 and a ground potential. Optical modulator 176 also includes a second loading capacitance structure (e.g., a plurality of capacitors 190) located proximate to second interferometric arm 182 and coupled between first drive signal electrode 184 and the ground potential. In addition, optical modulator 176 includes a third loading capacitance structure (e.g., a plurality of capacitors 192) located proximate to first interferometric arm 180 and coupled between second drive signal electrode 186 and the ground potential, and a fourth loading capacitance structure (e.g., a plurality of capacitors 194) located proximate to second interferometric arm 182 and coupled between second drive signal electrode 186 and the ground potential.

First drive signal electrode 184 is suitably configured to contribute to the modulation of optical signals in first interferometric arm 180 and in second interferometric arm 182. More specifically, capacitors 188 enable first drive signal electrode 184 to affect the optical signal carried in first interferometric arm 180, while capacitors 190 enable first drive signal electrode 184 to affect the optical signal carried in second interferometric arm 182. Similarly, second drive signal electrode 186 is suitably configured to contribute to the modulation of optical signals in first interferometric arm 180 and in second interferometric arm 182. More specifically, capacitors 192 enable second drive signal electrode 186 to affect the optical signal carried in first interferometric arm 180, while capacitors 194 enable second drive signal electrode 186 to affect the optical signal carried in second interferometric arm 182.

Loading capacitors 188 and loading capacitors 192 are positioned to provide an electric field in a particular direction relative to first interferometric arm 180. In the example embodiment shown in FIG. 6, loading capacitors 188 and loading capacitors 192 generate an electric field across first interferometric arm 180 in a direction from the respective positive capacitor electrodes toward the corresponding negative capacitor electrodes. In other words, the electric fields between loading capacitors 188 and the electric fields between loading capacitors 192 point “outward” relative to the area defined between first interferometric arm 180 and second interferometric arm 182. In contrast, loading capacitors 190 and loading capacitors 194 are positioned to provide an electric field in a particular direction relative to second interferometric arm 182. In the embodiment shown in FIG. 6, the electric fields between loading capacitors 190 and the electric fields between loading capacitors 194 also point “outward” relative to the area defined between first interferometric arm 180 and second interferometric arm 182; the direction of these electric fields are opposite to the direction of the electric fields corresponding to loading capacitors 188 and loading capacitors 192. As described in more detail below, this arrangement of loading capacitors is suitable for use with a dual in-phase driver assembly.

In accordance with one practical embodiment, the various loading capacitance structures are symmetric. For example, each of the individual loading capacitors may be dimensionally and electrically symmetric such that the individual capacitance of each capacitor is substantially equal and the phase modulation in each arm is equal and opposite. FIG. 6 depicts such an arrangement. The symmetric nature of the loading capacitance structures allows optical modulator subsystem 174 to modulate the optical signal while maintaining substantially zero chirp. If the loading capacitances are symmetrically designed, then little or no chirp will be produced even if there is a power imbalance between the two drive signal inputs. Each of the two inputs addresses both arms of the interferometer, so that the chirp is zero even if there is a power imbalance between inputs.

Another feature of this drive method is that the two inputs are driven in-phase, not in opposition. This is more compatible with high-speed, high-power drive amplifiers than a differential drive. Also, the in-phase drive method can be extended to more than two inputs, should the need arise.

Optical modulator subsystem 174 may include a suitably configured driver assembly 196. Driver assembly 196 obtains a data signal and amplifies or conditions the data signal for use with loaded-line optical modulator 176. Driver assembly 196 includes a first signal source 198 connected to first drive signal electrode 184 and a second signal source 200 connected to second drive signal electrode 186. First signal source 198 is configured to provide a first drive signal to first drive signal electrode 184 and second signal source 200 is configured to provide a second drive signal to second drive signal electrode 186. In accordance with one example embodiment of the invention, driver assembly 196 is suitably configured such that first signal source 198 generates a first in-phase drive signal 202 and second signal source 200 generates a second in-phase drive signal 204. In-phase drive signals are utilized in this embodiment due to the specific configuration of the loading capacitances in optical modulator 176.

The particular design of driver assembly 196 can vary according to the requirements of the subsystem. Indeed, any number of known RF design methodologies can be utilized to determine the configuration of a practical driver assembly 196. The example embodiment shown in FIG. 6 utilizes a single data input terminal, a common first stage amplifier, and two final high power amplifier stages representing first signal source 198 and second signal source 200. Driver assembly 196 may alternatively employ two separate data signal sources that do not share a common input data signal. Although not a requirement of the present invention, driver assembly 196 may be configured such that the first and second drive signals are substantially equal in magnitude.

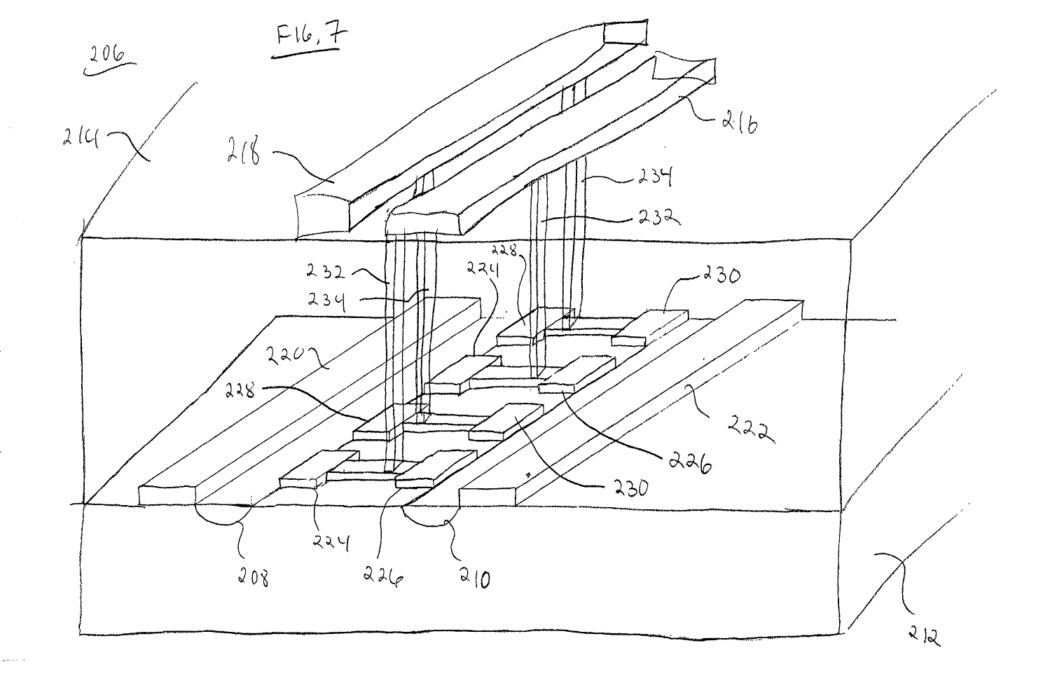

A dual-drive loaded line optical modulator can be implemented in a number of different ways, and the present invention is not limited to any specific practical implementation. As an example, FIG. 7 is a schematic perspective view of a loaded-line optical modulator 206 having dual drive electrodes. Optical modulator 206 is one practical realization of optical modulator 176 shown in FIG. 6. For the sake of clarity, the corresponding driver assembly is not shown in FIG. 7.

Optical modulator 206 includes an optical waveguide structure having a first interferometric arm 208 and a second interferometric arm 210 (the input and output waveguide branches are not shown in FIG. 7). The optical waveguide is suitably formed in a substrate material 212, e.g., a lithium niobate substrate. A layer of dielectric material, e.g., a polyimide dielectric layer 214, is formed over lithium niobate substrate 212. In the example embodiment shown in FIG. 7, a first drive signal electrode 216 and a second drive signal electrode 218 are both formed over dielectric layer 214, and a first ground electrode 220 and a second ground electrode 222 are both formed over lithium niobate substrate 212. In this embodiment, the continuous ground electrodes can be employed for modulation and transmission line purposes. Alternatively, the ground electrodes can be formed over dielectric layer 214 and modulation ground elements (connected to the ground electrodes) can be formed over lithium niobate substrate 212.

Optical modulator 206 includes loading capacitor electrodes 224 (for modulating optical signals in first interferometric arm 208) and loading capacitor electrodes 226 (for modulating optical signals in second interferometric arm 210) connected to first drive signal electrode 216. In addition, optical modulator 206 includes loading capacitor electrodes 228 (for modulating optical signals in first interferometric arm 208) and loading capacitor electrodes 230 (for modulating optical signals in second interferometric arm 210) connected to second drive signal electrode 218. Although FIG. 7 (and several other Figures) depicts four sets of loading capacitors, the present invention need not be limited to any specific number of capacitors or loading electrodes. The loading electrodes are connected to first drive signal electrode 216 with a suitable electrical conductor such as a number of vias 232. Similarly, loading electrodes can be connected to second drive signal electrode 218 with a number of vias 234.

Each loading electrode, in combination with one of the ground electrodes, provides a loading capacitance for optical modulator 206. For a symmetric configuration (as depicted in FIG. 7), each interferometric arm is loaded in substantially the same manner, i.e., the combined loading capacitance on first interferometric arm 208 is substantially equal to the combined loading capacitance on second interferometric arm 210. As described above, optical modulator 206 may employ modulation ground elements (similar to the loading capacitor electrodes) rather than continuous ground electrodes.

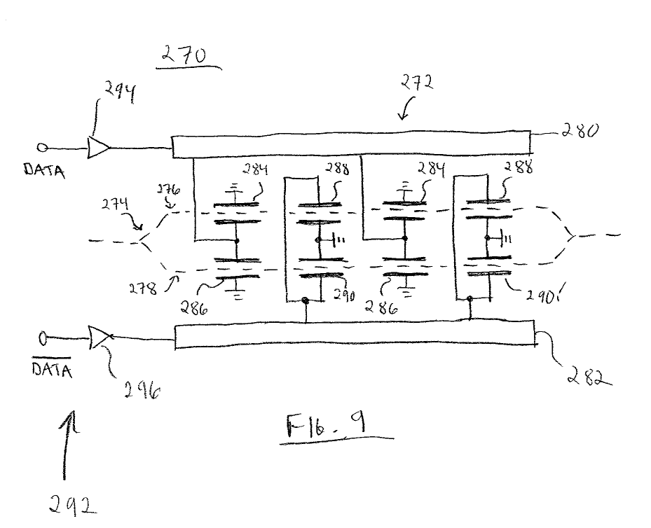

For applications where an adjustable chirp is desired, a dual-drive configuration with asymmetric loading capacitances can be used. The asymmetry is generated by the loading capacitances such that one interferometric arm is modulated more than the other interferometric arm. The chirp can be adjusted by adjusting the relative RF power applied to each drive signal electrode. FIG. 8 is a schematic representation of one example optical modulator subsystem 236 including a loaded-line optical modulator 238 with dual drive electrodes and asymmetric loading capacitors. Other than its use of asymmetric loading capacitances, optical modulator 238 is similar to optical modulator 176 (see FIG. 6) in many respects. Accordingly, some features common to optical modulator 176 will not be repeated in the following description of optical modulator 238.

Optical modulator 238 includes an optical waveguide 240 having a first interferometric arm 242 and a second interferometric arm 244, a first drive signal electrode 246, a second drive signal electrode 248, and a plurality of loading capacitors located proximate the two interferometric arms. Optical modulator 238 includes a first loading capacitance structure (e.g., a plurality of capacitors 250) located proximate to first interferometric arm 242 and coupled between first drive signal electrode 246 and a ground potential. Optical modulator 238 also includes a second loading capacitance structure (e.g., a plurality of capacitors 252) located proximate to second interferometric arm 244 and coupled between first drive signal electrode 246 and the ground potential. In addition, optical modulator 238 includes a third loading capacitance structure (e.g., a plurality of capacitors 254) located proximate to first interferometric arm 242 and coupled between second drive signal electrode 248 and the ground potential, and a fourth loading capacitance structure (e.g., a plurality of capacitors 256) located proximate to second interferometric arm 244 and coupled between second drive signal electrode 248 and the ground potential.

As depicted in FIG. 8, the various loading capacitance structures are asymmetric. For example, each set of two connected loading capacitors may be dimensionally and electrically asymmetric such that the individual capacitance of each capacitor is different. In FIG. 8, capacitors 250 and capacitors 252 are asymmetric, and capacitors 254 and capacitors 256 are asymmetric. The asymmetric nature of the loading capacitances enables optical modulator 238 to generate an adjustable nonzero chirp when driven with appropriate drive signals.

Optical modulator subsystem 236 may include a suitably configured driver assembly 258. Driver assembly 258 obtains a data signal and amplifies or conditions the data signal for use with loaded-line optical modulator 238. Driver assembly 258 includes a first signal source 260 connected to first drive signal electrode 246 and a second signal source 262 connected to second drive signal electrode 248. First signal source 260 is configured to provide a first drive signal 264 to first drive signal electrode 246 and second signal source 262 is configured to provide a second drive signal 266 to second drive signal electrode 248.

Driver assembly 258 may include or cooperate with a controller 268 configured to adjust at least one of the input drive signals. Controller 268 can employ any number of known techniques to accomplish the electronic control of the power corresponding to first drive signal 264 and/or second drive signal 266. For example, as depicted in FIG. 8, controller 268 may utilize electronically adjustable RF attenuators to control the power of the respective drive signals. By adjusting the relative RF power applied to the drive signal electrodes, the chirp can be regulated without using a differential drive arrangement. In this regard, controller 268 is configured to generate a nonzero chirp in the modulated optical signal.

The techniques of the present invention may also be embodied in a dual-drive loaded-line optical modulator having a complementary input. This is useful at frequencies and power levels where a complementary signal is the optimum input. For example, FIG. 9 is a schematic representation of an optical modulator subsystem 270 including a loaded-line modulator 272 with dual drive electrodes and symmetric loading capacitors. Optical modulator 272 is similar in some respects to the other optical modulators described above. Accordingly, some of the common features will not be repeated in the following description of optical modulator 272.

Optical modulator 272 includes an optical waveguide 274 having a first interferometric arm 276 and a second interferometric arm 278, a first drive signal electrode 280, a second drive signal electrode 282, and a plurality of loading capacitors located proximate the two interferometric arms. Optical modulator 272 includes a first loading capacitance structure (e.g., a plurality of capacitors 284) located proximate to first interferometric arm 276 and coupled between first drive signal electrode 280 and a ground potential. Optical modulator 272 also includes a second loading capacitance structure (e.g., a plurality of capacitors 286) located proximate to second interferometric arm 278 and coupled between first drive signal electrode 280 and the ground potential. In addition, optical modulator 272 includes a third loading capacitance structure (e.g., a plurality of capacitors 288) located proximate to first interferometric arm 276 and coupled between second drive signal electrode 280 and the ground potential, and a fourth loading capacitance structure (e.g., a plurality of capacitors 290) located proximate to second interferometric arm 278 and coupled between second drive signal electrode 282 and the ground potential.

Loading capacitors 284 are positioned to provide an electric field in a particular direction relative to first interferometric arm 276. In the example embodiment shown in FIG. 9, loading capacitors 284 generate an electric field across first interferometric arm 276 in a direction from the respective positive capacitor electrodes toward the corresponding negative capacitor electrodes. In other words, the electric fields between loading capacitors 284 point “outward” relative to the area defined between first interferometric arm 276 and second interferometric arm 278. In contrast, loading capacitors 288 are positioned such that the electric fields between loading capacitors 288 point “inward” relative to the area defined between first interferometric arm 276 and second interferometric arm 278. Similarly, the electric fields between loading capacitors 286 point “outward” and the electric fields between loading capacitors 290 point “inward” relative to the area defined between the two interferometric arms.

As shown in FIG. 9, the positive capacitor electrode of a loading capacitor 284 is connected to the positive capacitor electrode of a loading capacitor 286 between the two interferometric arms, while the respective negative capacitor electrodes are located at the opposite sides of the waveguide arms. In contrast, the negative capacitor electrode of a loading capacitor 288 is connected to the negative capacitor electrode of a loading capacitor 290 between the two interferometric arms, while the respective positive capacitor electrodes are located at the opposite sides of the waveguide arms. As described in more detail below, this arrangement of loading capacitors is suitable for use with a dual driver assembly having complementary inputs.

In accordance with one practical embodiment, the various loading capacitance structures are symmetric, as depicted in FIG. 9. Such an embodiment is suitable for use where little or no chirp is desired. If the loading capacitances are symmetrically designed, then little or no chirp will be produced even if there is a power imbalance between the two drive signal inputs. Alternatively, an optical modulator having asymmetric loading capacitances, along with a driver assembly having one or more adjustable signal outputs, can be utilized to generate a modulated optical signal having a controllable nonzero chirp (as described above in connection with FIG. 8).

Optical modulator subsystem 270 may include a suitably configured driver assembly 292 that generates complementary drive signals. For example, driver assembly 292 includes a first signal source 294 connected to first drive signal electrode 280 and a second signal source 296 connected to second drive signal electrode 282. First signal source 294 is configured to provide a first drive signal to first drive signal electrode 280 and second signal source 282 is configured to provide a second drive signal to second drive signal electrode 282. In accordance with one example embodiment of the invention, the first and second drive signals are complementary, i.e., the second drive signal is the inverse of the first drive signal. Complementary drive signals are utilized in this embodiment due to the specific configuration of the loading capacitances in optical modulator 272.

### EXAMPLE EMBODIMENT

The above techniques can be implemented in connection with an example loaded-line optical modulator on a flat (no etched ridges) lithium niobate substrate. The various layers and elements are as follows. First, titanium-diffused stripes that form optical waveguides, e.g., interferometric arms 208 and 210 shown in FIG. 7, below the lithium niobate surface. Second, an oxide buffer layer (not shown in FIG. 7) about 200 nm thick, completely covering the lithium niobate surface. Third, the modulating electrode layer. The modulating electrode layer is a 1 μm thick gold layer covering the entire surface of the oxide layer except for the areas surrounding the modulating electrodes, e.g., electrodes 224, 226, 228, and 230. The large area of gold at ground potential represented by electrodes 220, 222 forms the ground plane for the microstrip line as well as the ground electrodes for the modulating electrodes. The modulating electrodes are realized as strips, 3 μm wide and 113 μm long, just beside each of the two optical waveguides. The modulating electrode pairs are connected to each other by a 30 μm long connector in the middle. This pattern is repeated every 300 μm along the modulator length.

The next layer is a 50 μm thick polyimide dielectric layer, e.g., layer 214. Via holes formed within the dielectric layer are located every 300 μm to connect the upper microstrip line to the modulating electrodes, with the bottom of the via landing on the 30 μm long connector. The vias are fabricated by reactive ion etching and are typically 30 μm in diameter at the bottom and 100 μm in diameter at the top. The top layer is a gold stripe (200 μm wide and 1 μm thick) that forms the top conductor of a microstrip-type microwave transmission line. This stripe passes over the top of the via holes so that each of the 113 μm long modulating electrodes is connected to the microstrip line. Electrodes 216 and 218 may be realized by such gold stripes.

The example structure described above is a capacitively loaded microwave transmission line. The unloaded line, which would be just the microstrip line without the vias and loading electrodes, has an impedance of 35 ohms and a microwave refractive index of 1.49 (velocity is c/1.49). The capacitance of the loading electrodes reduces the impedance to 25 ohms and slows the velocity to a microwave index of 2.15, which matches the optical velocity in the waveguides. The 113 μm length for the loading electrodes provides the proper capacitance to achieve this velocity match. If the loading electrodes are longer, the microwave velocity will become too slow and it will not be effective at modulating the light at high speed.

The switching voltage of the modulator, referred to as V_{π}, is inversely proportional to the total length of the modulating electrodes (provided that the microwave and optical velocities match). The V_{π}L product of the 3 μm wide modulating electrodes placed next to a waveguide guiding light at 1550 nm is 71 V-mm (as determined by numerical modeling), so a modulator with a total length of 50 mm and having electrodes as described above, that is filling only 113/300 of the length, has a V_{π} of 3.8 volts at low frequency. Reduction of this voltage is a key goal of high-speed modulator design. Thus, electrodes longer than 113 μm would be preferable if possible.

Since less than half the total length of the modulator is actually covered by loading electrodes, one could add a second microstrip with a second set of 113 μm long loading electrodes interleaved with the first set of electrodes, without disturbing the positioning of the first set of electrodes. Now the total length covered by the modulating electrodes is doubled, to 226/300 of the 50 mm length, so the V, is halved (to 1.9 V) when both lines are driven with the same voltage.

This example structure has several advantages over conventional dual-drive schemes that make it more effective and much easier to use in practice. First, as detailed above, this is a simple, direct halving of the drive voltage. Second, because each of the lines affects both arms equally, the zero-chirp characteristics of a balanced interferometric modulator are preserved even in the presence of errors in the electrical power balance between the two strips. Third, because the two lines are driven in-phase, the mode of the coupled microstrip line (there will be some coupling due to the physical proximity of the two lines) is the even mode. It is easy to maintain this single microwave mode in this case by occasionally connecting the two lines together so the antisymmetric mode cannot propagate. This will eliminate the potentially undesirable effect of power transfer between lines that occurs when there is some power propagating in both the symmetric and antisymmetric modes. Finally, this optical modulator can be driven from a driver with two parallel output transistors, one driving each of the two lines, since the two lines are driven in-phase. This is a common design for increasing the output power of a power amplifier.

As another example, consider a case where non-zero chirp is desired. A typical situation where this arises is a 10 Gigabit/second link of a few hundred km length, where a small negative chirp is desired (for example, a chirp parameter α=−0.6). The chirp is the ratio of optical phase modulation to intensity modulation; devices are often characterized by a single number, α=(dφ/dt)/[(1/2I)(dI/dt)] where φ is the optical phase, I is the optical intensity, and the derivatives are taken at the point of maximum intensity change. For a Mach-Zehnder interferometric modulator with perfect extinction and electrodes on the two arms identical except for length, this works out to α=a/l, where one arm has electrodes of length l+a and the other arm has electrodes with length l−a (the sign is determined by the bias point and the electric field direction relative to the z-axis on the arm with the longer electrodes). The built-in chirp can be varied from −1 to +1 by changing the relative electrode length along each arm. This is illustrated schematically in FIG. 3.

Using the numerical example above where l=113 μm, if a chirp of α=−0.6 is desired, a=68 μm so the loading electrode should be built with length 45 μm along one arm and 181 μm along the other arm (and the bias point chosen such that the chirp is −0.6 and not +0.6). Since the switching voltage V_{π} only depends on the total length 2 l (assuming push-pull drive), V_{π} is unchanged by this change from zero chirp and it remains at 3.8V.

If an adjustable chirp is desired, the same type of procedure can be applied to the dual-drive design, as illustrated in FIG. 8. The set of loading electrodes connected to the first microstrip line is built with a longer length along the first arm than along the second arm, and the loading electrodes connected to the second line can be made with a longer length along the second arm. In the dual-drive example above, the electrode length could be made 196 μm along the first arm and 30 μm along the second arm for loads connected to the first microstrip line, and the reverse for loads connected to the second microstrip line. The chirp can then be varied from −0.73 to +0.73 by varying the drive power from all on the first microstrip line to all on the second microstrip line. This example design provides the same V_{π} as the balanced design, 1.9V on each microstrip line, when it is adjusted for zero chirp. However, when it is adjusted for nonzero chirp, the voltage on one line has to be increased while the voltage on the other must be decreased. In the extreme case of all the power on one line, the voltage required on that line is 3.8V, and so the voltage advantage of the dual drive is lost. In addition, since the lines are not necessarily driven with equal power, they must be separated by enough distance to minimize coupling effects. This design is therefore useful in cases where the need for adjustable chirp is important enough to justify giving up some of the advantages of the balanced dual-drive design.

The present invention has been described above with reference to a preferred embodiment. For instance, there are numerous alternative examples for implementing the techniques of the present invention. The numerical examples set forth above are merely used to demonstrate the practicality of the techniques, and not to limit the application of the invention to any particular case. Indeed, those skilled in the art having read this disclosure will recognize that changes and modifications may be made to the preferred embodiment without departing from the scope of the present invention. These and other changes or modifications are intended to be included within the scope of the present invention, as expressed in the following claims.

What is claimed is:

1. A loaded-line optical modulator comprising:
an optical waveguide having a first interferometric arm and a second interferometric arm;
a drive signal electrode shared by said first interferometric arm and said second interferometric arm;
a first loading capacitance structure coupled to said drive signal electrode and located proximate to said first interferometric arm; and
a second loading capacitance structure coupled to said drive signal electrode and located proximate to said second interferometric arm, said first loading capacitance structure having a different capacitance than said second loading capacitance structure.

2. A loaded-line optical modulator according to claim 1, wherein:
said first loading capacitance structure comprises a first plurality of capacitors that provide a first combined loading capacitance; and
said second loading capacitance structure comprises a second plurality of capacitors that provide a second combined loading capacitance different than said first combined loading capacitance.

3. A loaded-line optical modulator according to claim 2, wherein:
each of said first plurality of capacitors comprises a load electrode having a first length;
each of said second plurality of capacitors comprises a load electrode having a second length; and
said first length is different than said second length.

4. A loaded-line optical modulator according to claim 3, further comprising:
a first ground electrode corresponding to said first interferometric arm; and
a second ground electrode corresponding to said second interferometric arm; wherein:
each of said first plurality of capacitors comprises a ground element having said first length; and
each of said second plurality of capacitors comprises a ground element having said second length.

5. A loaded-line optical modulator according to claim 1, wherein said first loading capacitance structure and said second loading capacitance structure are configured to generate a nonzero chirp in a modulated optical signal.

6. A loaded-line optical modulator according to claim 1, wherein said first loading capacitance structure and said second loading capacitance structure are dimensionally asymmetric.

7. A loaded-line optical modulator comprising:
an optical waveguide having a first interferometric arm and a second interferometric arm;
a drive signal electrode configured to contribute to the modulation of optical signals in said first interferometric arm and in said second interferometric arm; and
a plurality of asymmetric loading capacitance structures connected to said drive signal electrode.

8. A loaded-line optical modulator according to claim 7, wherein said plurality of asymmetric loading capacitance structures comprises:
a first loading capacitance structure coupled to said drive signal electrode and located proximate to said first interferometric arm; and
a second loading capacitance structure coupled to said drive signal electrode and located proximate to said second interferometric arm.

9. A loaded-line optical modulator according to claim 8, wherein said first loading capacitance structure has a different capacitance than said second loading capacitance structure.

10. A loaded-line optical modulator according to claim 7, wherein said plurality of asymmetric loading capacitance structures are configured to generate a nonzero chirp in a modulated optical signal.

11. A loaded-line optical modulator according to claim 7, wherein said plurality of asymmetric loading capacitance structures are dimensionally asymmetric.

12. A loaded-line optical modulator comprising:
an optical waveguide having a first interferometric arm and a second interferometric arm;
a plurality of drive signal electrodes, each being connected to at least one pair of capacitance structures comprising:
a first loading capacitance structure located proximate to said first interferometric arm and coupled between said first drive signal electrode and a ground potential; and
a second loading capacitance structure located proximate to said second interferometric arm and coupled between said first drive signal electrode and a ground potential.

13. A loaded-line optical modulator according to claim 12, wherein said first loading capacitance structure and said second loading capacitance structure are dimensionally symmetric.

14. A loaded-line optical modulator according to claim 12, wherein said first loading capacitance structure and said second loading capacitance structure are each configured to provide substantially the same capacitance.

15. A loaded-line optical modulator according to claim 12, wherein said first loading capacitance structure and said second loading capacitance structure are dimensionally asymmetric.

16. A loaded-line optical modulator according to claim 15, wherein said first loading capacitance structure and said second loading capacitance structure are configured to generate a nonzero chirp in a modulated optical signal.

17. A loaded-line optical modulator according to claim 12, wherein:
a first one of said drive signal electrodes is connected to dimensionally symmetric pairs of capacitance structures; and
a second one of said drive signal electrodes is connected to dimensionally asymmetric capacitance structures.

18. A loaded-line optical modulator according to claim 12, wherein:
said first loading capacitance structure comprises a first plurality of capacitors that provide a first combined loading capacitance; and
said second loading capacitance structure comprises a second plurality of capacitors that provide a second combined loading capacitance different than said first combined loading capacitance.

19. A loaded-line optical modulator comprising:
an optical waveguide having a first interferometric arm and a second interferometric arm;
a first drive signal electrode;
a second drive signal electrode;
a first loading capacitance structure located proximate to said first interferometric arm and coupled between said first drive signal electrode and a ground potential;
a second loading capacitance structure located proximate to said second interferometric arm and coupled between said first drive signal electrode and a ground potential;
a third loading capacitance structure located proximate to said first interferometric arm and coupled between said second drive signal electrode and a ground potential; and
a fourth loading capacitance structure located proximate to said second interferometric arm and coupled between said second drive signal electrode and a ground potential.

20. A loaded-line optical modulator according to claim 19, wherein:
said first loading capacitance structure provides an electric field in a first direction relative to said first interferometric arm;
said second loading capacitance structure provides an electric field in a second direction relative to said second interferometric arm;
said third loading capacitance structure provides an electric field in said first direction relative to said first interferometric arm; and
said fourth loading capacitance structure provides an electric field in said second direction relative to said second interferometric arm.

21. A loaded-line optical modulator according to claim 20, wherein said first loading capacitance structure, said second loading capacitance structure, said third loading capacitance structure, and said fourth loading capacitance structure are dimensionally asymmetric.

22. A loaded-line optical modulator according to claim 19, wherein:
said first loading capacitance structure provides an electric field in a first direction relative to said first interferometric arm;
said second loading capacitance structure provides an electric field in a second direction relative to said second interferometric arm;
said third loading capacitance structure provides an electric field in said second direction relative to said first interferometric arm; and
said fourth loading capacitance structure provides an electric field in said first direction relative to said second interferometric arm.

23. A loaded-line optical modulator according to claim 22, wherein said first loading capacitance structure, said second loading capacitance structure, said third loading capacitance structure, and said fourth loading capacitance structure are dimensionally asymmetric.

24. A loaded-line optical modulator comprising:
an optical waveguide having a first interferometric arm and a second interferometric arm;
a first drive signal electrode having a first plurality of loading capacitors connected thereto, said first drive signal electrode being configured to contribute to the modulation of optical signals in said first interferometric arm and in said second interferometric arm; and
a second drive signal electrode having a second plurality of loading capacitors connected thereto, said second drive signal electrode being configured to contribute to the modulation of optical signals in said first interferometric arm and in said second interferometric arm.

25. A loaded-line optical modulator according to claim 24, wherein said first plurality of loading capacitors and said second plurality of loading capacitors are dimensionally symmetric.

26. A loaded-line optical modulator according to claim 25, wherein said first plurality of loading capacitors and said second plurality of loading capacitors are each configured to provide substantially the same capacitance.

27. A loaded-line optical modulator according to claim 24, wherein:
said first plurality of loading capacitors are dimensionally asymmetric, relative to each other; and
said second plurality of loading capacitors are dimensionally asymmetric, relative to each other.

28. A loaded-line optical modulator according to claim 27, wherein said first plurality of loading capacitors and said second plurality of loading capacitors are configured to generate a nonzero chirp in a modulated optical signal.

29. A loaded-line optical modulator according to claim 24, wherein:
said first plurality of loading capacitors comprises a first loading capacitor located proximate to said first interferometric arm and coupled between said first drive signal electrode and a ground potential, and a second loading capacitor located proximate to said second interferometric arm and coupled between said first drive signal electrode and a ground potential;
said second plurality of loading capacitors comprises a third loading capacitor located proximate to said first interferometric arm and coupled between said second drive signal electrode and a ground potential, and a fourth loading capacitor located proximate to said second interferometric arm and coupled between said second drive signal electrode and a ground potential.

30. A loaded-line optical modulator according to claim 29, wherein:
said first loading capacitor provides an electric field in a first direction relative to said first interferometric arm;
said second loading capacitor provides an electric field in a second direction relative to said second interferometric arm;
said third loading capacitor provides an electric field in said first direction relative to said first interferometric arm; and
said fourth loading capacitor provides an electric field in said second direction relative to said second interferometric arm.

31. A loaded-line optical modulator according to claim 30, wherein said first loading capacitor, said second loading capacitor, said third loading capacitor, and said fourth loading capacitor are dimensionally asymmetric.

32. A loaded-line optical modulator according to claim 29, wherein:
said first loading capacitor provides an electric field in a first direction relative to said first interferometric arm;
said second loading capacitor provides an electric field in a second direction relative to said second interferometric arm;
said third loading capacitor provides an electric field in said second direction relative to said first interferometric arm; and
said fourth loading capacitor provides an electric field in said first direction relative to said second interferometric arm.

33. A loaded-line optical modulator according to claim 32, wherein said first loading capacitor, said second loading capacitor, said third loading capacitor, and said fourth loading capacitor are dimensionally asymmetric.

34. An optical modulation subsystem comprising:
a loaded-line modulator comprising:
an optical waveguide having a first interferometric arm and a second interferometric arm;
a first drive signal electrode having a first plurality of loading capacitors, said first drive signal electrode being configured to contribute to the modulation of optical signals in said first interferometric arm and in said second interferometric arm; and
a second drive signal electrode having a second plurality of loading capacitors, said second drive signal electrode being configured to contribute to the modulation of optical signals in said first interferometric arm and in said second interferometric arm; and
a driver assembly comprising:
a first signal source connected to said first drive signal electrode, said first signal source being configured to provide a first drive signal to said first drive signal electrode; and
a second signal source connected to said second drive signal electrode, said second signal source being configured to provide a second drive signal to said second drive signal electrode.

35. A loaded-line optical modulator according to claim 34, wherein:
said first plurality of loading capacitors comprises a first loading capacitor located proximate to said first interferometric arm and coupled between said first drive signal electrode and a ground potential, and a second loading capacitor located proximate to said second interferometric arm and coupled between said first drive signal electrode and a ground potential;
said second plurality of loading capacitors comprises a third loading capacitor located proximate to said first interferometric arm and coupled between said second drive signal electrode and a ground potential, and a fourth loading capacitor located proximate to said second interferometric arm and coupled between said second drive signal electrode and a ground potential.

36. A loaded-line optical modulator according to claim 35, wherein:
said first loading capacitor provides an electric field in a first direction relative to said first interferometric arm;
said second loading capacitor provides an electric field in a second direction relative to said second interferometric arm;
said third loading capacitor provides an electric field in said first direction relative to said first interferometric arm; and
said fourth loading capacitor provides an electric field in said second direction relative to said second interferometric arm.

37. An optical modulation subsystem according to claim 36, wherein:
said first signal source is configured to provide a first in-phase drive signal to said first drive signal electrode; and
said second signal source is configured to provide a second in-phase drive signal to said second drive signal electrode.

38. A loaded-line optical modulator according to claim 35, wherein:
said first loading capacitor provides an electric field in a first direction relative to said first interferometric arm;
said second loading capacitor provides an electric field in a second direction relative to said second interferometric arm;
said third loading capacitor provides an electric field in said second direction relative to said first interferometric arm; and
said fourth loading capacitor provides an electric field in said first direction relative to said second interferometric arm.

39. An optical modulator subsystem according to claim 38, wherein:
said first signal source is configured to provide a first complementary drive signal to said first drive signal electrode; and
said second signal source is configured to provide a second complementary drive signal to said second drive signal electrode.

40. An optical modulator subsystem according to claim 34, wherein said first drive signal and said second drive signal are substantially equal in magnitude.

41. An optical modulator subsystem according to claim 40, wherein said first plurality of loading capacitors and said second plurality of loading capacitors are dimensionally symmetric.

42. An optical modulator subsystem according to claim 34, wherein:
said first plurality of loading capacitors are dimensionally asymmetric, relative to each other; and
said second plurality of loading capacitors are dimensionally asymmetric, relative to each other.

43. An optical modulator subsystem according to claim 42, further comprising a controller configured to adjust at least one of said first drive signal and said second drive signal.

44. An optical modulator subsystem according to claim 43, wherein said controller is further configured to generate a nonzero chirp in a modulated optical signal.
